(19) United States
(12) Patent Application Publication
(10) Pub. No.: US 2024/0073727 A1
(43) Pub. Date: Feb. 29, 2024

(54) GROUP BASED BEAM REPORTING FOR NON-SERVING CELLS

(71) Applicant: QUALCOMM Incorporated, San Diego, CA (US)

(72) Inventors: Yan ZHOU, San Diego, CA (US); Mostafa KHOSHNEVISAN, San Diego, CA (US); Fang YUAN, Beijing (CN); Tao LUO, San Diego, CA (US)

(21) Appl. No.: 18/260,540

(22) PCT Filed: Mar. 23, 2021
(86) PCT No.: PCT/CN2021/082240

§ 371 Date: Jul. 6, 2023

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may receive a plurality of reference signals associated with at least one beam group comprising a plurality of beams, wherein the plurality of beams includes one or more beams associated with one or more non-serving cells. The UE may transmit a group based beam report that includes one or more beam metrics associated with the at least one beam group. Numerous other aspects are described.

### FIELD OF THE DISCLOSURE

Aspects of the present disclosure generally relate to wireless communication and to techniques and apparatuses for group based beam reporting for non-serving cells.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory; and one or more processors, coupled to the memory, configured to: receive a plurality of reference signals associated with at least one beam group comprising a plurality of beams, wherein the plurality of beams includes one or more beams associated with one or more non-serving cells; and transmit a group based beam report that includes one or more beam metrics associated with the at least one beam group.

In some aspects, a base station for wireless communication includes a memory; and one or more processors, coupled to the memory, configured to: transmit, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and receive, from the UE, a group based beam report that includes the one or more beam metrics associated with the at least one beam group.

In some aspects, a method of wireless communication performed by a UE includes receiving a plurality of reference signals associated with at least one beam group comprising a plurality of beams, wherein the plurality of beams includes one or more beams associated with one or more non-serving cells; and transmitting a group based beam report that includes one or more beam metrics associated with the at least one beam group.

In some aspects, a method of wireless communication performed by a base station includes transmitting, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and receiving, from the UE, a group based beam report that includes the one or more beam metrics associated with the at least one beam group.

In some aspects, a non-transitory computer-readable medium storing a set of instructions for wireless communication includes one or more instructions that, when executed by one or more processors of a UE, cause the UE to: receive a plurality of reference signals associated with at least one beam group comprising a plurality of beams, wherein the plurality of beams includes one or more beams associated with one or more non-serving cells; and transmit a group based beam report that includes one or more beam metrics associated with the at least one beam group.

In some aspects, a non-transitory computer-readable medium storing a set of instructions for wireless communication includes one or more instructions that, when executed by one or more processors of a base station, cause the base station to: transmit, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and receive, from the UE, a group based beam report that includes the one or more beam metrics associated with the at least one beam group.

In some aspects, an apparatus for wireless communication includes means for receiving a plurality of reference signals associated with at least one beam group comprising a plurality of beams, wherein the plurality of beams includes one or more beams associated with one or more non-serving cells; and means for transmitting a group based beam report that includes one or more beam metrics associated with the at least one beam group.

In some aspects, an apparatus for wireless communication includes means for transmitting, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and means for receiving, from the UE, a group based beam report that includes the one or more beam metrics associated with the at least one beam group.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antenna, RF chains, power amplifiers, modulators, buffer, processor(s), interleaver, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of multi-transmit-receive point (TRP) communications, in accordance with the present disclosure.

FIG. 4 is a diagram illustrating an example associated with group based beam reporting for non-serving cells, in accordance with the present disclosure.

FIGS. 5 and 6 are diagrams illustrating example processes associated with group based beam reporting for non-serving cells, in accordance with the present disclosure.

FIGS. 7 and 8 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

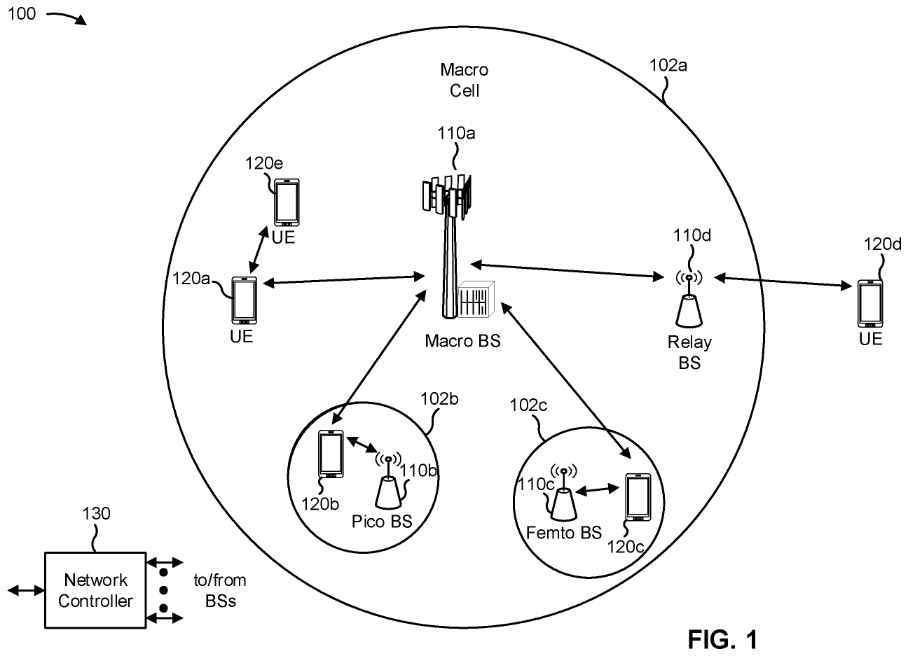

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

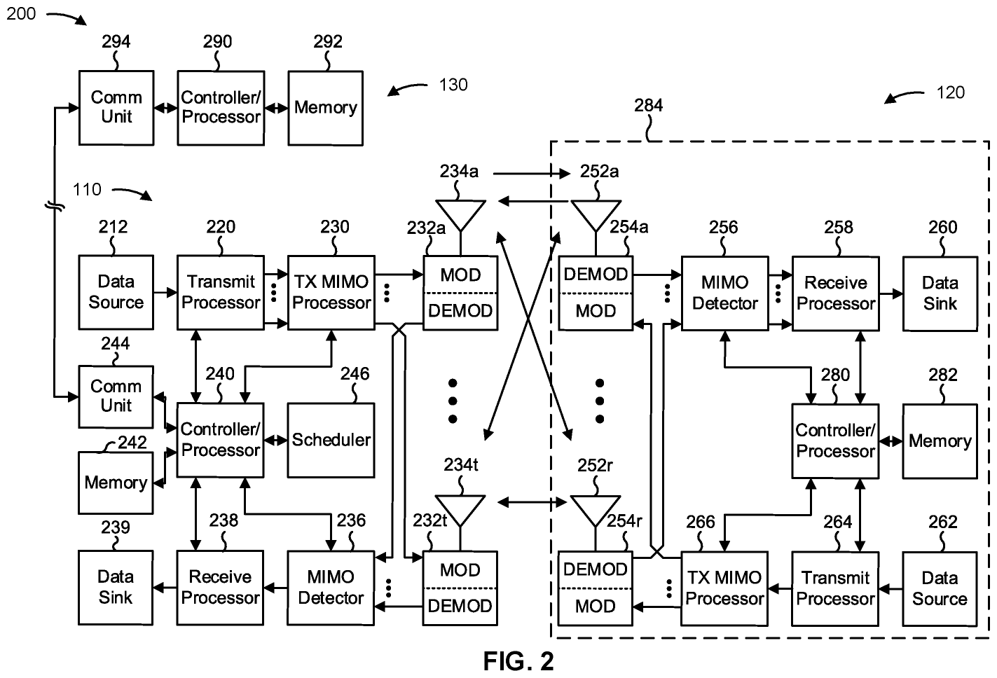

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

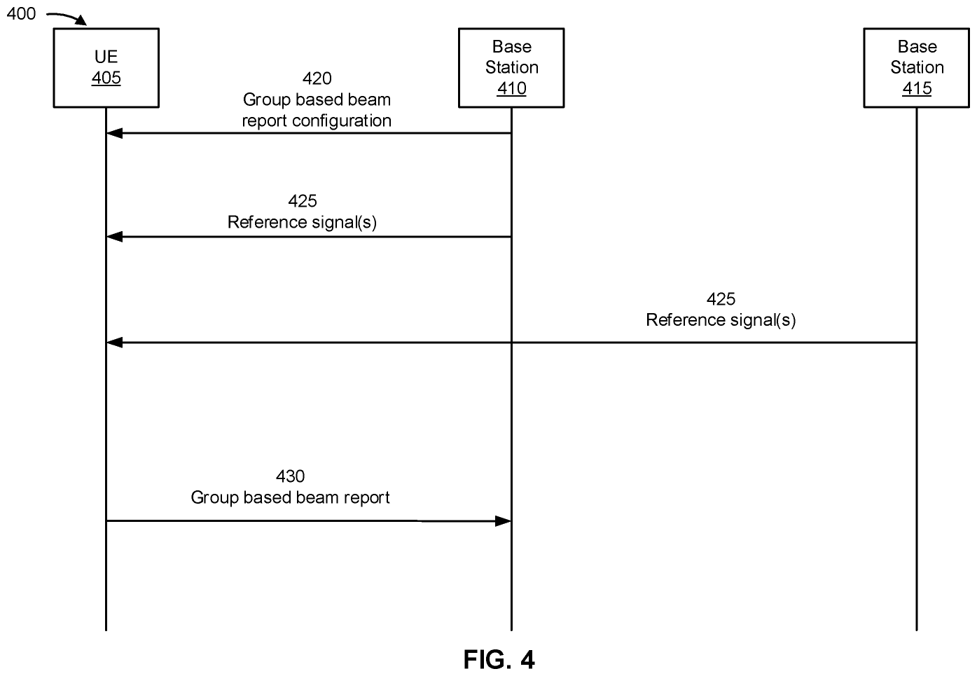

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-6.

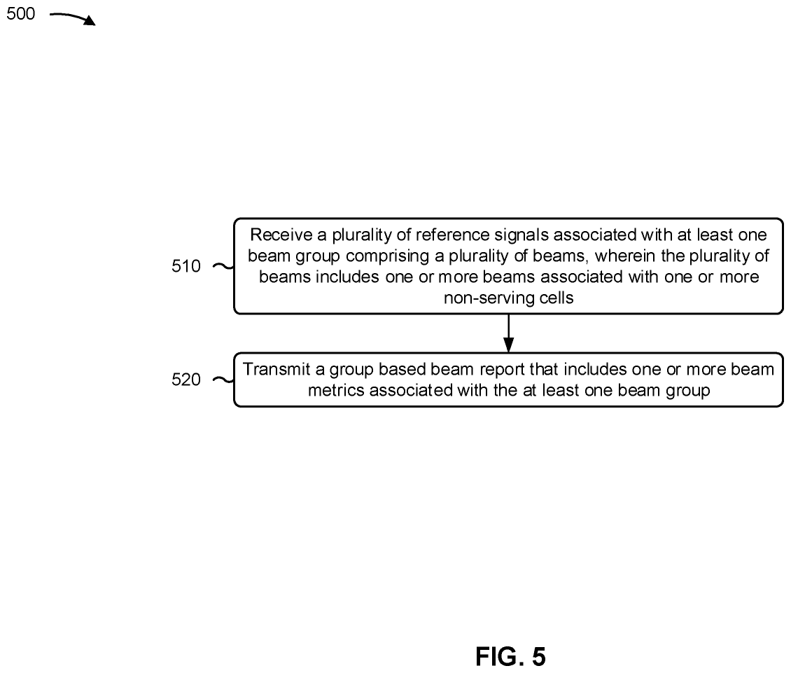

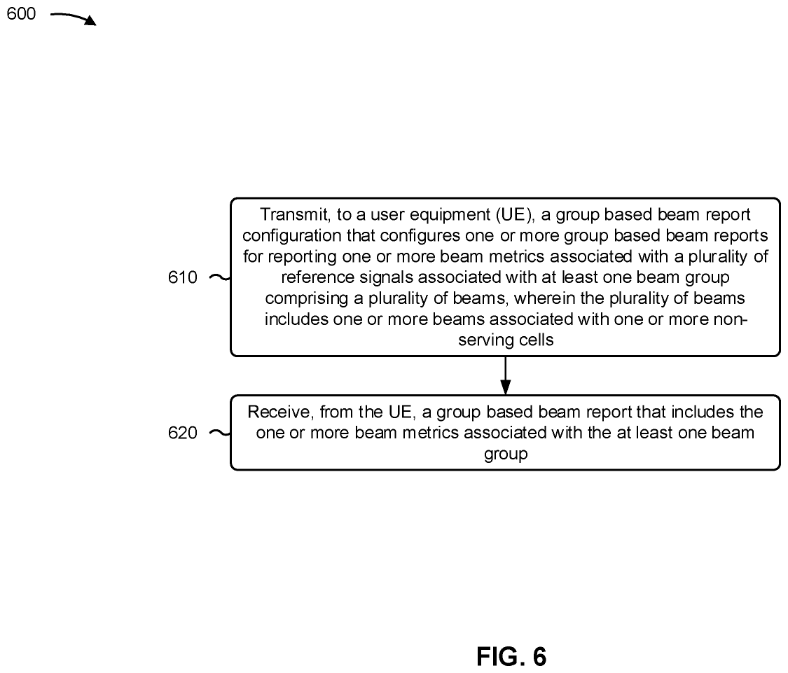

Controller/processor 240 of base station 110, controller/processor 280 of UE 120, and/or any other component(s) of FIG. 2 may perform one or more techniques associated with group-based beam reporting for non-serving cells, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, the UE includes means for receiving a plurality of reference signals associated with at least one beam group comprising a plurality of beams, wherein the plurality of beams includes one or more beams associated with one or more non-serving cells; or means for transmitting a group based beam report that includes one or more beam metrics associated with the at least one beam group. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station includes means for transmitting, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; or means for receiving, from the UE, a group based beam report that includes the one or more beam metrics associated with the at least one beam group. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

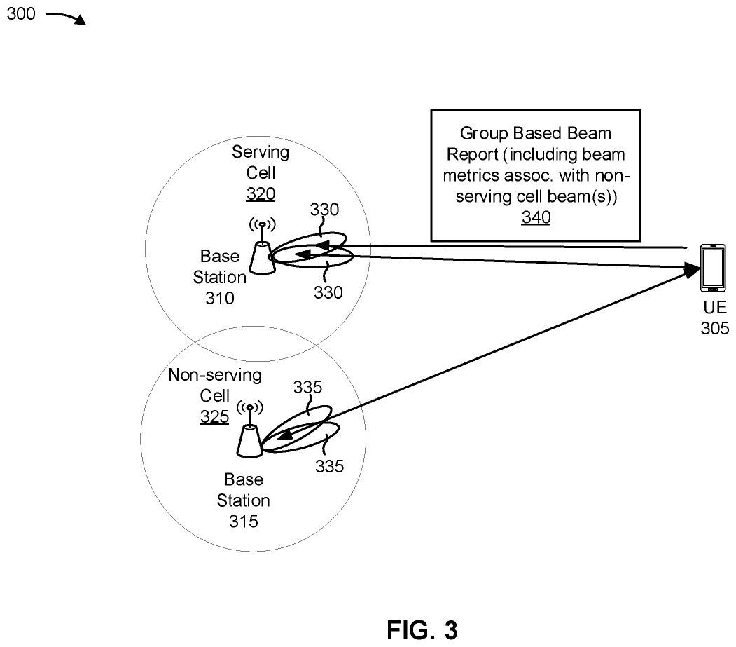

FIG. 3 is a diagram illustrating an example 300 of multi-TRP communication (sometimes referred to as multi-panel communication), in accordance with the present disclosure. As shown in FIG. 3, a UE 305 may communicate with a base station 310 and a base station 315. The base stations 310 and 315 may be referred to as TRPs and may include base stations, relay devices, and/or integrated access and backhaul (IAB) nodes, among other examples. As shown, the base station 310 may be associated with a serving cell 320 and the base station 315 may be associated with a non-serving cell 325. Any number of other base stations may be associated with the serving cell 320 and/or the non-serving cell 325.

The base station 310 may communicate using one or more beams 330 and the base station 315 may communicate using one or more beams 335. In some cases, the UE 305 may be configured to determine one or more metrics associated with beams and to provide a group based beam report to a base station. In some cases, a base station (e.g., the base station 310) may configure the UE 305 to provide a group based beam report to the base station 310 that includes one or more metrics associated with a group of beams 330 associated with the serving cell 320. However, in a situation in which the configuration limits group based beam reports to report on beams associated with the serving cell 320 may result in unnecessary overhead and delay in scenarios in which the UE 305 determines metrics associated with beams 335 associated with a non-serving cell (e.g., to support inter-cell mobility), because the UE 305 would produce an additional beam report for those beams.

Some aspects of the techniques and apparatuses described herein provide for group based beam reporting for non-serving cells. In some aspects, for example, the UE 305 may receive a number of reference signals using a number of beams, at least one of which may be associated with the non-serving cell 325. The UE 305 may be configured to provide a group based beam report 340 that includes one or more metrics associated with a plurality of beams associated with one or more groups of beams, including at least one beam 335 associated with the non-serving cell 325. In some aspects, to report a beam in the beam report, the UE 305 may report an index of a reference signal corresponding to the reported beam and a beam metric measured at least on the reference signal corresponding to the reported beam. In this way, some aspects may facilitate a more flexible group based beam reporting technique that may reduce overhead and delay, resulting in positive impacts to network performance.

As indicated above, FIG. 3 is provided as an example. Other examples may differ from what is described with respect to FIG. 3.

FIG. 4 is a diagram illustrating an example 400 associated with group based beam reporting for non-serving cells, in accordance with the present disclosure. As shown in FIG. 4, a UE 405 may communicate with a base station 410 and a base station 415. In some aspects, the base station 410 may be associated with a serving cell and the base station 415 may be associated with a non-serving cell.

As shown by reference number 420, the base station 410 may transmit, and the UE 405 may receive, a group based beam report configuration. In some aspects, the group based beam report configuration may be carried using a radio resource control (RRC) message. The group based beam report configuration may indicate one or more beam metrics to be reported. In some aspects, the one or more beam metrics include at least one of a layer one reference signal received power (L1-RSRP) or a layer one signal to interference plus noise ratio (L1-SINR).

In some aspects, the base station 410 and/or the base station 415 may transmit, and the UE 405 may receive, one or more configurations of one or more reference signals. In some aspects, the base station 410 may configure reference signals to be transmitted by the base station 410 and/or the base station 415. In some aspects, the base station 410 and/or the base station 415 may transmit, and the UE 405 may receive, one or more configurations of one or more beams. In some aspects, the base station 410 may configure beams to be used for transmission by the base station 410 and/or the base station 415.

In some aspects, the group based beam report configuration may configure simultaneous reception and/or reporting of beams. In some aspects, for example, the UE 405 may transmit, and the base station 410 may receive, an indication of a UE capability associated with simultaneous reception of beams. The base station 410 may transmit the group based beam report configuration that configures simultaneous reception and/or reporting of beams based at least in part on the indication of the UE capability.

As shown by reference number 425, the base station 410 may transmit one or more reference signals and the base station 415 may transmit one or more reference signals. The plurality of reference signals may be associated with at least one beam group including a plurality of beams. The plurality of beams may include one or more beams associated with one or more non-serving cells. As shown by reference number 430, the UE 405 may transmit, and the base station 410 may receive a group based beam report that includes one or more beam metrics associated with the at least one beam group.

In some aspects, the at least one beam group may include a plurality of beam groups. Each beam group of the plurality of beam groups may include at least one beam of the one or more beams associated with the one or more non-serving cells. Each beam group of the plurality of beam groups that includes the at least one beam of the one or more beams associated with the one or more non-serving cells may include only the at least one beam of the one or more beams associated with the one or more non-serving cells. A beam group of the plurality of beam groups that includes the at least one beam of the one or more beams associated with the one or more non-serving cells may include at least one beam associated with a serving cell.

In some aspects, a quantity of beam groups of the at least one beam group may be based at least in part on a capability of the UE 405. In some aspects, a quantity of beams of the one or more beams associated with one or more non-serving cells may be based at least in part on a capability of the UE 405.

In some aspects, the UE 405 may receive, from a serving cell (e.g., from the base station 410), a reference signal that indicates a beam associated with a non-serving cell of the one or more non-serving cells. The beam may be configured as a quasi co-location (QCL) source associated with the non-serving cell. For example, the UE 405 may receive the reference signals configured by the RRC configurations dedicated to the serving cell (e.g., base station 410), and the reference signal may have a beam indication by a TCI or a spatial relation information, and the source reference signal in the TCI or the spatial relation information to provide QCL or spatial filter may be configured by the RRC configurations dedicated to the non-serving cell (e.g., base station 415). In some aspects, the UE 405 may receive, from a non-serving cell (e.g., from base station 415) of the one or more non-serving cells, a reference signal that indicates a beam associated with a non-serving cell of the one or more non-serving cells. In some aspects, the UE 405 may receive the reference signals configured by the RRC configurations dedicated to the non-serving cell (e.g., base station 415). In some other aspects, the RRC configurations dedicated to the non-serving cell (e.g., base station 415) may be received through the serving cell (e.g., base station 410).

In some aspects, the plurality of reference signals may be associated with a beam group of the at least one beam group, and the UE 405 may receive the plurality of reference signals simultaneously. In some aspects, a first reference signal of the plurality of reference signals may be associated with a first beam group of the at least one beam group and a second reference signal of the plurality of reference signals may be associated with a second beam group of the at least one beam group. The UE 405 may receive the first reference signal and the second reference signal simultaneously. In some aspects, the group based beam report may be associated with a first beam, and the UE 405 may transmit an additional group based beam report associated with a second beam. The UE 405 may receive a first reference signal associated with the first beam and a second reference signal associated with the second beam simultaneously.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 405) performs operations associated with group based beam reporting for non-serving cells.

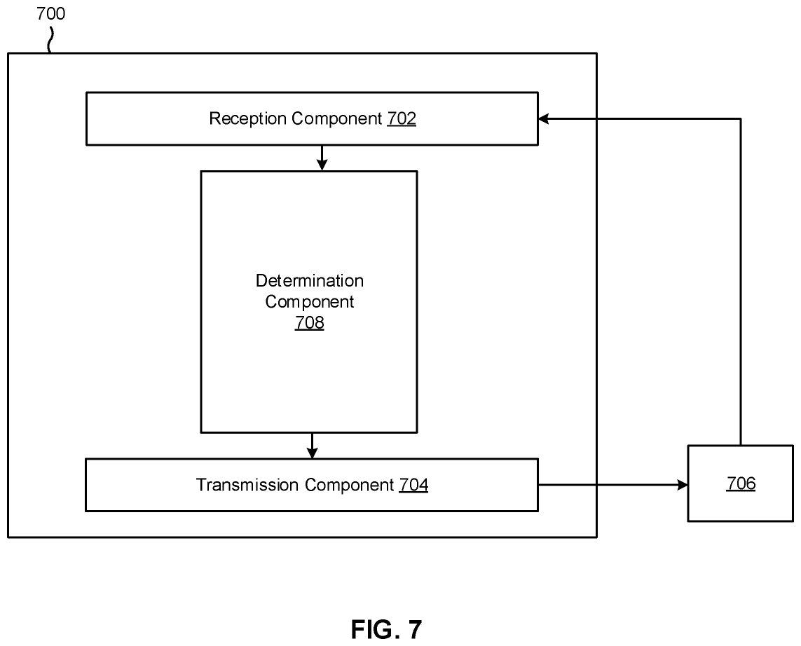

As shown in FIG. 5, in some aspects, process 500 may include receiving a plurality of reference signals associated with at least one beam group comprising a plurality of beams, wherein the plurality of beams includes one or more beams associated with one or more non-serving cells (block 510). For example, the UE (e.g., using reception component 702, depicted in FIG. 7) may receive a plurality of reference signals associated with at least one beam group comprising a plurality of beams, wherein the plurality of beams includes one or more beams associated with one or more non-serving cells, as described above.

As further shown in FIG. 5, in some aspects, process 500 may include transmitting a group based beam report that includes one or more beam metrics associated with the at least one beam group (block 520). For example, the UE (e.g., using transmission component 704, depicted in FIG. 7) may transmit a group based beam report that includes one or more beam metrics associated with the at least one beam group, as described above.

Process 500 may include additional aspects, such as any single aspect or any combination of aspects described below and/or in connection with one or more other processes described elsewhere herein.

In a first aspect, the at least one beam group comprises a plurality of beam groups.

In a second aspect, alone or in combination with the first aspect, each beam group of the plurality of beam groups includes at least one beam of the one or more beams associated with the one or more non-serving cells.

In a third aspect, alone or in combination with one or more of the first and second aspects, each beam group of the plurality of beam groups that includes the at least one beam of the one or more beams associated with the one or more non-serving cells includes only the at least one beam of the one or more beams associated with the one or more non-serving cells.

In a fourth aspect, alone or in combination with one or more of the first through third aspects, a beam group of the plurality of beam groups that includes the at least one beam of the one or more beams associated with the one or more non-serving cells includes at least one beam associated with a serving cell.

In a fifth aspect, alone or in combination with one or more of the first through fourth aspects, a quantity of beam groups of the at least one beam group is based at least in part on a capability of the UE.

In a sixth aspect, alone or in combination with one or more of the first through fifth aspects, a quantity of beams of the one or more beams associated with one or more non-serving cells is based at least in part on a capability of the UE.

In a seventh aspect, alone or in combination with one or more of the first through sixth aspects, receiving the plurality of reference signals comprises receiving, from a serving cell, a reference signal that indicates a beam associated with a non-serving cell of the one or more non-serving cells.

In an eighth aspect, alone or in combination with one or more of the first through seventh aspects, the beam is configured as a quasi co-location source associated with the non-serving cell.

In a ninth aspect, alone or in combination with one or more of the first through eighth aspects, process 500 includes receiving, from the serving cell, a configuration of the reference signal.

In a tenth aspect, alone or in combination with one or more of the first through ninth aspects, receiving the plurality of reference signals comprises receiving, from a non-serving cell of the one or more non-serving cells, a reference signal that indicates a beam associated with a non-serving cell of the one or more non-serving cells.

In an eleventh aspect, alone or in combination with one or more of the first through tenth aspects, process 500 includes receiving, from the non-serving cell, a configuration of the beam.

In a twelfth aspect, alone or in combination with one or more of the first through eleventh aspects, the one or more beam metrics include at least one of an L1-RSRP or an L1-SINR.

In a thirteenth aspect, alone or in combination with one or more of the first through twelfth aspects, process 500 includes receiving a group based beam report configuration that indicates the one or more beam metrics.

In a fourteenth aspect, alone or in combination with one or more of the first through thirteenth aspects, the plurality of reference signals are associated with a beam group of the at least one beam group, and wherein receiving the plurality of reference signals comprises receiving the plurality of reference signal simultaneously.

In a fifteenth aspect, alone or in combination with one or more of the first through fourteenth aspects, a first reference signal of the plurality of reference signals is associated with a first beam group of the at least one beam group and a second reference signal of the plurality of reference signals is associated with a second beam group of the at least one beam group, and wherein receiving the plurality of reference signals comprises receiving the first reference signal and the second reference signal simultaneously.

In a sixteenth aspect, alone or in combination with one or more of the first through fifteenth aspects, the group based beam report is associated with a first beam, the method further comprising transmitting an additional group based beam report associated with a second beam, and wherein receiving the plurality of reference signals comprises receiving a first reference signal associated with the first beam and a second reference signal associated with the second beam simultaneously.

In a seventeenth aspect, alone or in combination with one or more of the first through sixteenth aspects, process 500 includes transmitting an indication of a UE capability associated with simultaneous reception of beams.

In an eighteenth aspect, alone or in combination with one or more of the first through seventeenth aspects, process 500 includes receiving a group based beam report configuration that configures simultaneous reception of beams.

In a nineteenth aspect, alone or in combination with one or more of the first through eighteenth aspects, the group based beam report configuration is carried using a radio resource control message.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 410) performs operations associated with group based beam reporting for non-serving cells.

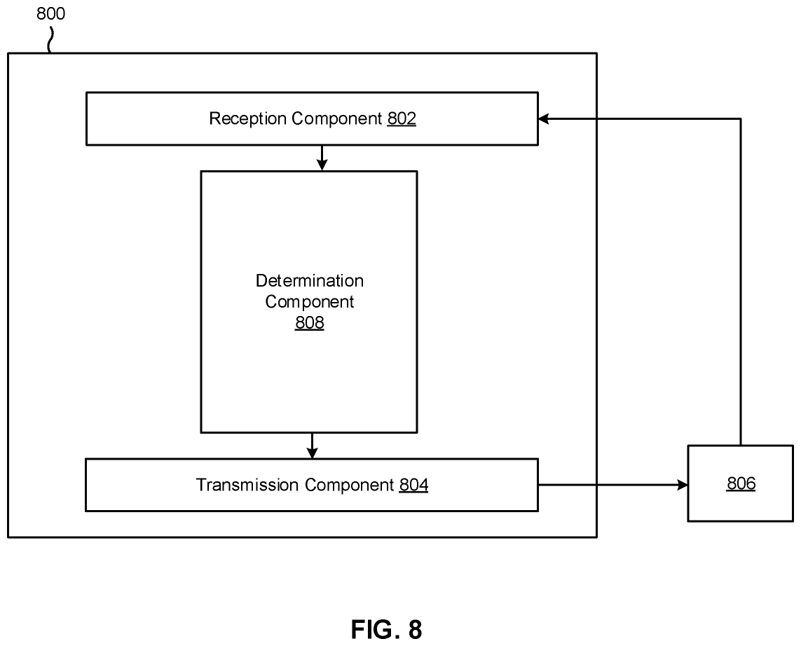

As shown in FIG. 6, in some aspects, process 600 may include transmitting, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells (block 610). For example, the base station (e.g., using transmission component 804, depicted in FIG. 8) may transmit, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells, as described above.

As further shown in FIG. 6, in some aspects, process 600 may include receiving, from the UE, a group based beam report that includes the one or more beam metrics associated with the at least one beam group (block 620). For example, the base station (e.g., using reception component 802, depicted in FIG. 8) may receive, from the UE, a group based beam report that includes the one or more beam metrics associated with the at least one beam group, as described above.

Process 600 may include additional aspects, such as any single aspect or any combination of aspects described below and/or in connection with one or more other processes described elsewhere herein.

In a first aspect, the at least one beam group comprises a plurality of beam groups.

In a second aspect, alone or in combination with the first aspect, each beam group of the plurality of beam groups includes at least one beam of the one or more beams associated with the one or more non-serving cells.

In a third aspect, alone or in combination with one or more of the first and second aspects, each beam group of the plurality of beam groups that includes the at least one beam of the one or more beams associated with the one or more non-serving cells includes only the at least one beam of the one or more beams associated with the one or more non-serving cells.

In a fourth aspect, alone or in combination with one or more of the first through third aspects, a beam group of the plurality of beam groups that includes the at least one beam of the one or more beams associated with the one or more non-serving cells includes at least one beam associated with a serving cell.

In a fifth aspect, alone or in combination with one or more of the first through fourth aspects, a quantity of beam groups of the at least one beam group is based at least in part on a capability of the UE.

In a sixth aspect, alone or in combination with one or more of the first through fifth aspects, a quantity of beams of the one or more beams associated with one or more non-serving cells is based at least in part on a capability of the UE.

In a seventh aspect, alone or in combination with one or more of the first through sixth aspects, transmitting the plurality of reference signals comprises transmitting, from a serving cell, a reference signal that indicates a beam associated with a non-serving cell of the one or more non-serving cells.

In an eighth aspect, alone or in combination with one or more of the first through seventh aspects, the beam is configured as a quasi co-location source associated with the non-serving cell.

In a ninth aspect, alone or in combination with one or more of the first through eighth aspects, process 600 includes transmitting, to the UE, a configuration of the reference signal.

In a tenth aspect, alone or in combination with one or more of the first through ninth aspects, the one or more beam metrics include at least one of an L1-RSRP or an L1-SINR.

In an eleventh aspect, alone or in combination with one or more of the first through tenth aspects, process 600 includes transmitting a group based beam report configuration that indicates the one or more beam metrics.

In a twelfth aspect, alone or in combination with one or more of the first through eleventh aspects, the plurality of reference signals are associated with a beam group of the at least one beam group, and wherein transmitting the plurality of reference signals comprises transmitting the plurality of reference signal simultaneously.

In a thirteenth aspect, alone or in combination with one or more of the first through twelfth aspects, a first reference signal of the plurality of reference signals is associated with a first beam group of the at least one beam group and a second reference signal of the plurality of reference signals is associated with a second beam group of the at least one beam group, and wherein transmitting the plurality of reference signals comprises receiving the first reference signal and the second reference signal simultaneously.

In a fourteenth aspect, alone or in combination with one or more of the first through thirteenth aspects, the group based beam report is associated with a first beam, the method further comprising receiving an additional group based beam report associated with a second beam, and wherein transmitting the plurality of reference signals comprises transmitting a first reference signal associated with the first beam and a second reference signal associated with the second beam simultaneously.

In a fifteenth aspect, alone or in combination with one or more of the first through fourteenth aspects, process 600 includes receiving an indication of a UE capability associated with simultaneous reception of beams.

In a sixteenth aspect, alone or in combination with one or more of the first through fifteenth aspects, process 600 includes transmitting a group based beam report configuration that configures simultaneous reception of beams.

In a seventeenth aspect, alone or in combination with one or more of the first through sixteenth aspects, the group based beam report configuration is carried using a radio resource control message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a determination component 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5 or a combination thereof. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The reception component 702 may receive a plurality of reference signals associated with at least one beam group comprising a plurality of beams, wherein the plurality of beams includes one or more beams associated with one or more non-serving cells. The transmission component 704 may transmit a group based beam report that includes one or more beam metrics associated with the at least one beam group.

The reception component 702 may receive, from the serving cell, a configuration of the reference signal. The reception component 702 may receive, from the non-serving cell, a configuration of the beam. The reception component 702 may receive a group based beam report configuration that indicates the one or more beam metrics. The transmission component 704 may transmit an indication of a UE capability associated with simultaneous reception of beams. The reception component 702 may receive a group based beam report configuration that configures simultaneous reception of beams.

The determination component 708 may determine one or more metrics associated with a reference signal and/or generate a group based beam report, among other examples. In some aspects, the determination component 708 may include one or more antennas, a modulator, a transmit MIMO processor, a transmit processor, a controller/processor, a memory, or a combination thereof, of the UE described above in connection with FIG. 2. In some aspects, the determination component 708 may include the reception component 702 and/or the transmission component 704.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a block diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the base station described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the base station described above in connection with FIG. 2. In some aspects, the transmission component 804 may be co-located with the reception component 802 in a transceiver.

The transmission component 804 may transmit, to a UE, a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells. The reception component 802 may receive, from the UE, a group based beam report that includes the one or more beam metrics associated with the at least one beam group.

The transmission component 804 may transmit, to the UE, a configuration of the reference signal. The transmission component 804 may transmit a group based beam report configuration that indicates the one or more beam metrics. The reception component 802 may receive an indication of a UE capability associated with simultaneous reception of beams. The transmission component 804 may transmit a group based beam report configuration that configures simultaneous reception of beams.

The determination component 808 may determine a group based beam report configuration, a reference signal configuration, and/or a resource allocation, among other examples. In some aspects, the determination component 808 may include one or more antennas, a modulator, a transmit MIMO processor, a transmit processor, a controller/processor, a memory, or a combination thereof, of the base station described above in connection with FIG. 2. In some aspects, the determination component 808 may include the reception component 802 and/or the transmission component 804.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a plurality of reference signals associated with at least one beam group comprising a plurality of beams, wherein the plurality of beams includes one or more beams associated with one or more non-serving cells; and transmitting a group based beam report that includes one or more beam metrics associated with the at least one beam group.

Aspect 2: The method of Aspect 1, wherein the at least one beam group comprises a plurality of beam groups.

Aspect 3: The method of Aspect 2, wherein each beam group of the plurality of beam groups includes at least one beam of the one or more beams associated with the one or more non-serving cells.

Aspect 4: The method of Aspect 3, wherein each beam group of the plurality of beam groups that includes the at least one beam of the one or more beams associated with the one or more non-serving cells includes only the at least one beam of the one or more beams associated with the one or more non-serving cells.

Aspect 5: The method of either of Aspects 3 or 4, wherein a beam group of the plurality of beam groups that includes the at least one beam of the one or more beams associated with the one or more non-serving cells includes at least one beam associated with a serving cell.

Aspect 6: The method of any of Aspects 1-5, wherein a quantity of beam groups of the at least one beam group is based at least in part on a capability of the UE.

Aspect 7: The method of any of Aspects 1-6, wherein a quantity of beams of the one or more beams associated with one or more non-serving cells is based at least in part on a capability of the UE.

Aspect 8: The method of any of Aspects 1-7, wherein receiving the plurality of reference signals comprises receiving, from a serving cell, a reference signal that indicates a beam associated with a non-serving cell of the one or more non-serving cells.

Aspect 9: The method of Aspect 8, wherein the beam is configured as a quasi co-location source associated with the non-serving cell.

Aspect 10: The method of either of Aspects 8 or 9, further comprising receiving, from the serving cell, a configuration of the reference signal.

Aspect 11: The method of any of Aspects 1-10, wherein receiving the plurality of reference signals comprises receiving, from a non-serving cell of the one or more non-serving cells, a reference signal that indicates a beam associated with a non-serving cell of the one or more non-serving cells.

Aspect 12: The method of Aspect 11, further comprising receiving, from the non-serving cell, a configuration of the beam.

Aspect 13: The method of any of Aspects 1-12, wherein the one or more beam metrics include at least one of: a layer one reference signal received power, or a layer one signal to interference plus noise ratio.

Aspect 14: The method of Aspect 13, further comprising receiving a group based beam report configuration that indicates the one or more beam metrics.

Aspect 15: The method of any of Aspects 1-14, wherein the plurality of reference signals are associated with a beam group of the at least one beam group, and wherein receiving the plurality of reference signals comprises receiving the plurality of reference signal simultaneously.

Aspect 16: The method of any of Aspects 1-15, wherein a first reference signal of the plurality of reference signals is associated with a first beam group of the at least one beam group and a second reference signal of the plurality of reference signals is associated with a second beam group of the at least one beam group, and wherein receiving the plurality of reference signals comprises receiving the first reference signal and the second reference signal simultaneously.

Aspect 17: The method of any of Aspects 1-17, wherein the group based beam report is associated with a first beam, the method further comprising transmitting an additional group based beam report associated with a second beam, and wherein receiving the plurality of reference signals comprises receiving a first reference signal associated with the first beam and a second reference signal associated with the second beam simultaneously.

Aspect 18: The method of any of Aspects 1-17, further comprising transmitting an indication of a UE capability associated with simultaneous reception of beams.

Aspect 19: The method of any of Aspects 1-18, further comprising receiving a group based beam report configuration that configures simultaneous reception of beams.

Aspect 20: The method of Aspect 19, wherein the group based beam report configuration is carried using a radio resource control message.

Aspect 21: A method of wireless communication performed by a base station, comprising: transmitting, to a user equipment (UE), a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and receiving, from the UE, a group based beam report that includes the one or more beam metrics associated with the at least one beam group.

Aspect 22: The method of Aspect 21, wherein the at least one beam group comprises a plurality of beam groups.

Aspect 23: The method of Aspect 22, wherein each beam group of the plurality of beam groups includes at least one beam of the one or more beams associated with the one or more non-serving cells.

Aspect 24: The method of Aspect 23, wherein each beam group of the plurality of beam groups that includes the at least one beam of the one or more beams associated with the one or more non-serving cells includes only the at least one beam of the one or more beams associated with the one or more non-serving cells.

Aspect 25: The method of either of Aspects 23 or 24, wherein a beam group of the plurality of beam groups that includes the at least one beam of the one or more beams associated with the one or more non-serving cells includes at least one beam associated with a serving cell.

Aspect 26: The method of any of Aspects 21-25, wherein a quantity of beam groups of the at least one beam group is based at least in part on a capability of the UE.

Aspect 27: The method of any of Aspects 21-26, wherein a quantity of beams of the one or more beams associated with one or more non-serving cells is based at least in part on a capability of the UE.

Aspect 28: The method of any of Aspects 21-27, wherein transmitting the plurality of reference signals comprises transmitting, from a serving cell, a reference signal that indicates a beam associated with a non-serving cell of the one or more non-serving cells.

Aspect 29: The method of Aspect 28, wherein the beam is configured as a quasi co-location source associated with the non-serving cell.

Aspect 30: The method of either of Aspects 28 or 29, further comprising transmitting, to the UE, a configuration of the reference signal.

Aspect 31: The method of any of Aspects 21-30, wherein the one or more beam metrics include at least one of: a layer one reference signal received power, or a layer one signal to interference plus noise ratio.

Aspect 32: The method of Aspect 31, further comprising transmitting a group based beam report configuration that indicates the one or more beam metrics.

Aspect 33: The method of any of Aspects 21-32, wherein the plurality of reference signals are associated with a beam group of the at least one beam group, and wherein transmitting the plurality of reference signals comprises transmitting the plurality of reference signal simultaneously.

Aspect 34: The method of any of Aspects 21-33, wherein a first reference signal of the plurality of reference signals is associated with a first beam group of the at least one beam group and a second reference signal of the plurality of reference signals is associated with a second beam group of the at least one beam group, and wherein transmitting the plurality of reference signals comprises receiving the first reference signal and the second reference signal simultaneously.

Aspect 35: The method of any of Aspects 21-34, wherein the group based beam report is associated with a first beam, the method further comprising receiving an additional group based beam report associated with a second beam, and wherein transmitting the plurality of reference signals comprises transmitting a first reference signal associated with the first beam and a second reference signal associated with the second beam simultaneously.

Aspect 36: The method of any of Aspects 21-35, further comprising receiving an indication of a UE capability associated with simultaneous reception of beams.

Aspect 37: The method of any of Aspects 21-36, further comprising transmitting a group based beam report configuration that configures simultaneous reception of beams.

Aspect 38: The method of Aspect 37, wherein the group based beam report configuration is carried using a radio resource control message.

Aspect 39: An apparatus for wireless communication at a device, comprising a processor; memory coupled with the processor; and instructions stored in the memory and executable by the processor to cause the apparatus to perform the method of one or more Aspects of Aspects 1-20.

Aspect 40: A device for wireless communication, comprising a memory and one or more processors coupled to the memory, the memory and the one or more processors configured to perform the method of one or more Aspects of Aspects 1-20.

Aspect 41: An apparatus for wireless communication, comprising at least one means for performing the method of one or more Aspects of Aspects 1-20.

Aspect 42: A non-transitory computer-readable medium storing code for wireless communication, the code comprising instructions executable by a processor to perform the method of one or more Aspects of Aspects 1-20.

Aspect 43: A non-transitory computer-readable medium storing a set of instructions for wireless communication, the set of instructions comprising one or more instructions that, when executed by one or more processors of a device, cause the device to perform the method of one or more Aspects of Aspects 1-20.

Aspect 44: An apparatus for wireless communication at a device, comprising a processor; memory coupled with the processor; and instructions stored in the memory and executable by the processor to cause the apparatus to perform the method of one or more Aspects of Aspects 21-38.

Aspect 45: A device for wireless communication, comprising a memory and one or more processors coupled to the memory, the memory and the one or more processors configured to perform the method of one or more Aspects of Aspects 21-38.

Aspect 46: An apparatus for wireless communication, comprising at least one means for performing the method of one or more Aspects of Aspects 21-38.

Aspect 47: A non-transitory computer-readable medium storing code for wireless communication, the code comprising instructions executable by a processor to perform the method of one or more Aspects of Aspects 21-38.

Aspect 48: A non-transitory computer-readable medium storing a set of instructions for wireless communication, the set of instructions comprising one or more instructions that, when executed by one or more processors of a device, cause the device to perform the method of one or more Aspects of Aspects 21-38.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a plurality of reference signals associated with at least one beam group comprising a plurality of beams, wherein the plurality of beams includes one or more beams associated with one or more non-serving cells; and
transmit a group based beam report that includes one or more beam metrics associated with the at least one beam group.

2. The UE of claim 1, wherein the at least one beam group comprises a plurality of beam groups, and wherein each beam group of the plurality of beam groups includes at least one beam of the one or more beams associated with the one or more non-serving cells.

3. The UE of claim 2, wherein each beam group of the plurality of beam groups that includes the at least one beam of the one or more beams associated with the one or more non-serving cells includes only the at least one beam of the one or more beams associated with the one or more non-serving cells.

4. The UE of claim 3, wherein a beam group of the plurality of beam groups that includes the at least one beam of the one or more beams associated with the one or more non-serving cells includes at least one beam associated with a serving cell.

5. The UE of claim 1, wherein at least one of a quantity of beam groups of the at least one beam group or a quantity of beams of the one or more beams associated with one or more non-serving cells is based at least in part on a capability of the UE.

6. The UE of claim 1, wherein the one or more processors, to receive the plurality of reference signals, are configured to receive, from a serving cell, a reference signal that indicates a beam associated with a non-serving cell of the one or more non-serving cells.

7. The UE of claim 6, wherein the beam is configured as a quasi co-location source associated with the non-serving cell.

8. The UE of claim 6, wherein the one or more processors are further configured to receive, from the serving cell, a configuration of the reference signal.

9. The UE of claim 1, wherein the one or more processors, to receive the plurality of reference signals, are configured to receive, from a non-serving cell of the one or more non-serving cells, a reference signal that indicates a beam associated with a non-serving cell of the one or more non-serving cells.

10. The UE of claim 9, wherein the one or more processors are further configured to receive, from the non-serving cell, a configuration of the beam.

11. The UE of claim 1, wherein the one or more processors are further configured to receive a group based beam report configuration that indicates the one or more beam metrics, wherein the one or more beam metrics include at least one of:
a layer one reference signal received power, or
a layer one signal to interference plus noise ratio.

12. The UE of claim 1, wherein the plurality of reference signals are associated with a beam group of the at least one beam group, and wherein receiving the plurality of reference signals comprises receiving the plurality of reference signal simultaneously.

13. The UE of claim 1, wherein a first reference signal of the plurality of reference signals is associated with a first beam group of the at least one beam group and a second reference signal of the plurality of reference signals is associated with a second beam group of the at least one beam group, and wherein receiving the plurality of reference signals comprises receiving the first reference signal and the second reference signal simultaneously.

14. The UE of claim 1, wherein the group based beam report is associated with a first beam, the method further comprising transmitting an additional group based beam report associated with a second beam, and wherein receiving the plurality of reference signals comprises receiving a first reference signal associated with the first beam and a second reference signal associated with the second beam simultaneously.

15. The UE of claim 1, wherein the one or more processors are further configured to transmit an indication of a UE capability associated with simultaneous reception of beams.

16. The UE of claim 1, wherein the one or more processors are further configured to receive a group based beam report configuration that configures simultaneous reception of beams.

17. A base station for wireless communication, comprising:
a memory; and
one or more processors, coupled to the memory, configured to:
transmit, to a user equipment (UE), a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and
receive, from the UE, a group based beam report that includes the one or more beam metrics associated with the at least one beam group.

18. The base station of claim 17, wherein the at least one beam group comprises a plurality of beam groups, and wherein each beam group of the plurality of beam groups includes at least one beam of the one or more beams associated with the one or more non-serving cells.

19. The base station of claim 18, wherein each beam group of the plurality of beam groups that includes the at least one beam of the one or more beams associated with the one or more non-serving cells includes only the at least one beam of the one or more beams associated with the one or more non-serving cells.

20. The base station of claim 19, wherein a beam group of the plurality of beam groups that includes the at least one beam of the one or more beams associated with the one or more non-serving cells includes at least one beam associated with a serving cell.

21. The base station of claim 17, wherein at least one of a quantity of beam groups of the at least one beam group or a quantity of beams of the one or more beams associated with one or more non-serving cells is based at least in part on a capability of the UE.

22. The base station of claim 17, wherein the one or more processors, to transmit the plurality of reference signals, are configured to transmit, from a serving cell, a reference signal that indicates a beam associated with a non-serving cell of the one or more non-serving cells.

23. The base station of claim 22, wherein the beam is configured as a quasi co-location source associated with the non-serving cell.

24. The base station of claim 17, wherein the one or more processors are further configured to transmit a group based beam report configuration that indicates the one or more beam metrics, wherein the one or more beam metrics include at least one of:
a layer one reference signal received power, or
a layer one signal to interference plus noise ratio.

25. The base station of claim 24, wherein the plurality of reference signals are associated with a beam group of the at least one beam group, and wherein transmitting the plurality of reference signals comprises transmitting the plurality of reference signal simultaneously.

26. The base station of claim 17, wherein a first reference signal of the plurality of reference signals is associated with a first beam group of the at least one beam group and a second reference signal of the plurality of reference signals is associated with a second beam group of the at least one beam group, and wherein transmitting the plurality of reference signals comprises receiving the first reference signal and the second reference signal simultaneously.

27. The base station of claim 17, wherein the group based beam report is associated with a first beam, wherein the one or more processors are further configured to receive an additional group based beam report associated with a second beam, and wherein the one or more processors, to transmit the plurality of reference signals, are configured to transmit a first reference signal associated with the first beam and a second reference signal associated with the second beam simultaneously.

28. The base station of claim 17, wherein the one or more processors are further configured to:
receive an indication of a UE capability associated with simultaneous reception of beams; and
transmit a group based beam report configuration that configures simultaneous reception of beams based at least in part on the indication of the UE capability.

29. A method of wireless communication performed by a user equipment (UE), comprising:
receiving a plurality of reference signals associated with at least one beam group comprising a plurality of beams, wherein the plurality of beams includes one or more beams associated with one or more non-serving cells; and
transmitting a group based beam report that includes one or more beam metrics associated with the at least one beam group.

30. A method of wireless communication performed by a base station, comprising:
transmitting, to a user equipment (UE), a group based beam report configuration that configures one or more group based beam reports for reporting one or more beam metrics associated with a plurality of reference signals associated with at least one beam group comprising a plurality of beams, wherein the plurality of beams includes one or more beams associated with one or more non-serving cells; and
receiving, from the UE, a group based beam report that includes the one or more beam metrics associated with the at least one beam group.
